(19) United States
(12) Patent Application Publication
(10) Pub. No.: US 2025/0104085 A1
(43) Pub. Date: Mar. 27, 2025

(54) SECURE TRANSACTION TERMINAL GATEWAY

(71) Applicant: NCR Atleos Corporation, Atlanta, GA (US)

(72) Inventors: Alexander William Whytock, Perthshire (GB); David J. Sleeman, Dundee (GB)

(21) Appl. No.: 18/372,824

(22) Filed: Sep. 26, 2023

(51) Int. Cl. G06Q 20/40; G06Q 20/10

(52) U.S. Cl. CPC G06Q 20/4093; G06Q 20/1085; G06Q 20/40975

(57) ABSTRACT

A secure transaction terminal gateway device is provided. The gateway device includes a single motherboard. The motherboard includes an application processing environment and a security processing environment. Peripheral connections and communications are directly processed and authenticated directly on the security processing environment and indirectly communicated from the secure processing environment to the application processing environment. Communication between the application processing environment and security processing environment is made via an on-motherboard wired secure connection between an application environment port and a security environment port. In an embodiment, the single motherboard is an automated teller machine (ATM) motherboard.

### BACKGROUND

A variety of different transaction terminals exist across many different industries. For example, a point-of-sale (POS) terminal is operated by a cashier to assist a customer during a checkout. A self-service terminal (SST) is operated by a customer to perform a self-service transaction. Transaction terminals can also include a media handling device to accept and dispense bank notes, checks, and/or cash. Transaction terminals that include a media handling device need to be secure because thieves are continuously attempting to thwart security and access the currency in the media handling devices.

One type of SST that requires a significant amount of security is an automated teller machine (ATM). ATMs can be located inside business, outside business, and in drive-through locations. As soon as a security attack on an ATM is detected, hardware and/or software is redesigned to address the security attack. Unfortunately, this is a never-ending cycle because thieves often devise attacks that reveal security vulnerabilities in the redesigned hardware and/or software.

ATMs are also unique in that they require centralized processing for purposes of accessing a large financial network, accessing accounts, authorizing the accounts, and dispensing currency to customers. Centralized processing is harder to secure than is decentralized processing. Moreover, the ATMs require a large number of peripheral devices, which provide security access points that thieves can attempt to exploit in attacks. Unfortunately, the peripheral devices are necessary to handle currency, authenticate currency, securely store currency, dispense currency, validate custom accounts, authenticate customer personal identification numbers (PINs), etc.

### SUMMARY

In various embodiments, a secure transaction terminal gateway and methods of operating the gateway are presented. A secure transaction terminal gateway device is provided. The gateway device includes a single motherboard, which includes an application node and a security node connected via an on-motherboard wired secure connection between an application environment port and a security environment port. Peripheral connections and communications are directly processed and authenticated on the security processing environment and indirectly communicated, as needed, from the secure processing environment to the application processing environment over the on-motherboard wired secure connection. External network communications and media-based transaction applications are processed directly on the application node and indirectly communicated, as needed, to the security node via the on-motherboard wired secure connection.

### BRIEF DESCRIPTION OF THE DRAWINGS

FIG. 1 is a diagram of a system for a secure transaction terminal gateway, according to an example embodiment.

FIG. 2 is a flow diagram of a method for operating a secure transaction terminal gateway, according to an example embodiment.

FIG. 3 is a flow diagram of another method for operating a secure transaction terminal gateway according to an example embodiment.

### DETAILED DESCRIPTION

Thieves evolve their attacks at an alarming pace to penetrated both hardware and software security on transaction terminals with media handling devices. Shortly after redesigned hardware and/or software are released to address a given security attack, the thieves have already exposed a vulnerability in the redesigned hardware and/or software.

As stated above, security can be challenging for transactions terminals with media handling devices because of the necessity to perform centralized processing via the terminals and because of the large number of necessary peripheral devices, which include the media handling device themselves. The peripheral devices are potential vulnerable access points which the thieves can use to penetrate, circumvent, and/or corrupt the centralized processing.

These issues are resolved with the secure transaction terminal gateway presented herein and below. A single motherboard or printed circuit board (PCB) includes physically separated processing environments. An application environment for performing the centralized processing and a security environment for handling all security, connections, and interactions with peripheral devices of the secure transaction terminal gateway. Each processing environment includes its own independent processor or set of processors. The two environments are interfaced on the single motherboard via a single secure bus connection. Applications necessary for centralized processing are executed within the application environment on the application environment's processor. Interactions with the peripherals and security processing are executed within the security environment on the security environment's processor. In an embodiment, data sent to and received from the two separate and independent environments are custom encrypted and provided over the single bus connection.

Application based security requires a “soft” security approach whereas device including peripheral device security requires a “hard” security approach. The single motherboard architecture, presented herein, provides the necessary level of security by establishing two nodes on the motherboard. A first node represented in the architecture by the isolated application environment and the second node represented in the architecture by the isolated security environment.

The nodes are connected together via an on-board single bus secure connection. The application node or processing environment handles network-based communication and the centralized processing necessary for media or currency-based transactions. The secure node or secure processing environment handles all peripheral device communications for the peripherals of the secure transaction terminal gateway. This allows software control of the peripheral devices via on-chip resources or building blocks of the security node and thereby removes the necessitate that the peripheral devices include such resources of building blocks on their own independent PCBs. This also reduces the number of control PCBs necessary to secure the peripheral devices and their communications during a currency-based transaction.

In an embodiment, communications between the security processing environment and the peripheral devices is achieved using encrypted I2C communications. In an embodiment, the application processing environment includes a low-cost device integrated into the single motherboard, such as Raspberry PI®, etc. because the bulk of security and the peripheral connections are handled exclusively by the security processing environment.

As used herein, “security processing environment,” “security environment,” “security chip architecture,” and “security node” may be used interchangeably and synonymously. This refers to a chip architecture for an independent device with hardware resources (e.g., processor, memory, Input/Output (I/O) peripheral ports, secure connection port, wireless transceivers, etc.) and software resources (e.g., operating system (OS), application software, firmware, peripheral device drivers, etc.).

As used herein, “application processing environment,” “application environment,” “application chip architecture,” and “application node” may be used interchangeably and synonymously. This refers to a chip architecture for an independent device with hard resources (e.g., processing, memory, storage, network port, secure connection port, etc.) and software resources (e.g., operating system (OS), application software, firmware, etc.).

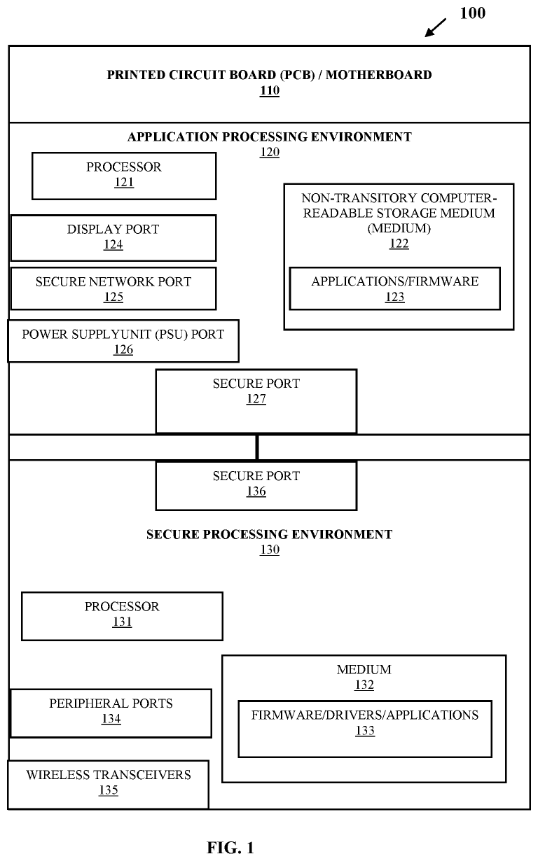

FIG. 1 is a diagram of a system 100 for a secure transaction terminal gateway, according to an example embodiment. System 100 is shown in simplified form with only those components necessary for understanding the teachings provided herein illustrated. Notably, more and/or less components can be provided without departing from the teachings provided herein. Furthermore, the arrangement of the components can be modified from what is illustrated without departing from the teachings provided herein.

System 100 includes two separate chip architectures for two separate and customized devices. The two chip architectures include an application processing environment 120 and a secure processing environment 130. The two chip architectures 120 and 130 are integrated together on a single motherboard 110 or single PCB 110 as a transaction terminal gateway device. Accordingly, “motherboard/PCB 110” and “transaction terminal gateway device 110” may be used interchangeably and synonymously herein.

Application processing environment 120 includes a processor 121 and a non-transitory computer-readable storage medium (herein after just “medium”) 122, which includes sets of executable instructions for applications/firmware 123. When the processor 121 executes the instructions, this causes the processor 121 to perform operations discussed herein and below with respect to 123.

Application processing environment 120 further includes a display port 124, a secure network port 125, a power supply unit (PS) port 126, and a secure internal or on-board port 127. Secure network port 125 permits an external motherboard network connect(s). For example, a financial network connection with the transaction terminal is an automated teller machine (ATM), a local branch server connection with the terminal is an ATM, etc. PSU port 126 provides a power supply connection. Secure port 127 provides a data connection between application node 120 and secure node 130. In an embodiment, secure port is an internally wired universal serial bus (USB) port.

In an embodiment, display port 124 is for attaching an administrative or maintenance monitor directly to application node 120. Thus, application node 120 and its state can be examined by a service engineer with an externally connected display or monitor. In an embodiment, the display port is a port for HDMI (high-definition multimedia interface), mini-HDMI, etc.

Secure processing environment 130 includes a processor 131 and medium 132, which includes sets of instructions for firmware/peripheral device drivers/applications 133. When processor 131 executes the instructions, this causes processor 131 to perform operations discussed herein and below with respect to 133.

Secure processing environment 130 further includes peripheral ports 134, one or more wireless transceivers 135, and secure port 136. The peripheral ports 134 include ports, by way of example only, for a media handling peripheral device, a keypad peripheral device, a touch display peripheral device, a power control peripheral device, a media shutter peripheral device, a weigh scale peripheral device, a scanner peripheral device, a bag scale peripheral device, a combined weigh scale and scanner peripheral device, a camera peripheral device, etc. The media handling peripheral device can include a variety of modules, such as a media infeed/dispense module, upper media transport module, one or more media verification modules, a media deskew module, a media diverter module a reject bin module, a media recycler module, an intermediate media transport module, a lower media transport module, a media safe module, etc.

Secure processing environment 130 also includes at least one contactless wireless transceiver 135. For example, secure processing environment 130 a near filed communication (NFC) transceiver, a low range radio frequency (RF) transceiver (e.g., Bluetooth® transceiver, etc.), and others.

In an embodiment, a variety of peripheral based integrated circuits can be integrated into security node 130. For example, an encrypted personal identification number (PIN also referred to as “EPP” herein) circuit can be integrated into security node 130. When this is done, a conventional EPP can be removed and replaced with a conventional keypad peripheral because the security-based processing using encryption, hashing, etc. is performed on the integrated circuit of the security node 130.

The secure processing environment 130 further includes secure port 136. This mirrors the secure port 127 of the application node 120 and provides data communications between application node 120 and security node 130. In an embodiment, the connection between ports 127 and 136 is made via a USB cable or made via a wired USB connection on motherboard 110.

All direct peripheral communications to and from peripheral devices of the security node 130 are processed on security node 136 via processor 131. Applications 123 of application node 120 indirectly interact with the peripheral devices through secure port 127, secure port 136, and processor 131, which executes firmware/device drivers/applications 133. That is, system 100 provides a secure gateway between two independent devices 120 and 130 to process centralized media-based transactions with security associated with the peripheral devices handled by processor 131 when executing firmware/device drivers/applications 133.

The security node 130 executes device drivers 133 and security applications 133 when establishing connections and communicating with the peripheral devices over the peripheral ports 134. In an embodiment, the connections are authenticated prior to be established with the peripheral devices by security applications 133. In an embodiment, communications over the authenticated connections are custom encrypted.

In an embodiment, security-based operations associated with encrypting and hashing an entered PIN on a keypad peripheral device is performed by security applications 133, with a hash value or nonce for a given cash dispense operation provided by security node 130 to a corresponding application 123 of application node 120 over an on-motherboard wired secure connection made between application node 120 and security node 130 using ports 127 and 136. The corresponding application 123 provides the hash value or nonce for the entered pin to an external financial network server over secure network port 125 for purposes of receiving an authentication for the dispense operation from the external financial network server. Assuming an authentication is received, the corresponding application 123 provides the authentication and an amount to dispense from a media handling peripheral device to security node 130 over the on-motherboard wired secure connection. A corresponding security application 133 verifies the authentication and sends a corresponding instruction to dispense the amount over an encrypted connection to the media handling peripheral device where the currency in the amount is dispensed to a customer who is requesting the cash dispense operation.

In an embodiment, communications over security port 127 and secure port 136 between application node 120 and security node 130 are encrypted using private-public key pairs. In an embodiment, the transaction terminal gateway device 110 is an ATM motherboard.

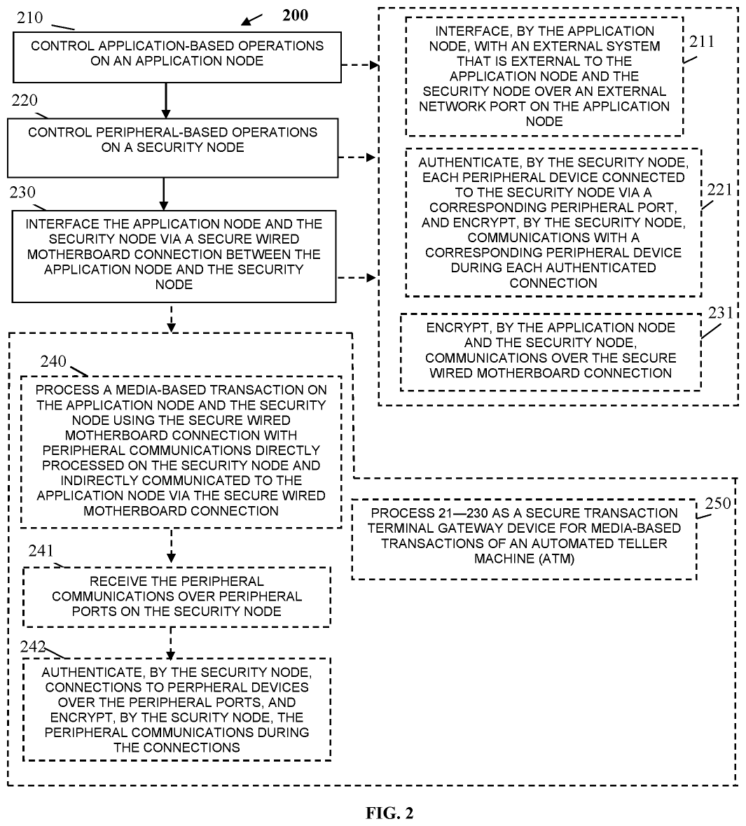

FIG. 2 is a diagram of a method 200 for operating a secure transaction terminal gateway device 110, according to an example embodiment. The software module(s) that implements the method 200 is referred to as a “security manager.” The security manager is implemented as executable instructions programmed and residing within memory and/or a non-transitory computer-readable (processor-readable) storage medium and executed by one or more processors of one or more devices. The processor(s) of the device(s) that executes the security manager are specifically configured and programmed to process the security manager. The security manager may or may not have access to one or more network connections during its processing. Any network connections used are wired, wireless, or a combination of wired and wireless.

In an embodiment, the device that executes the security manager is secure transaction terminal gateway device 110. In an embodiment, the secure transaction terminal gateway device 110 is an ATM, a POS terminal, or an SST. In an embodiment, the terminal gateway device 110 includes a peripheral connection to a media handling device.

At 210, the security manager controls application-based operations on an application node 120. That is, all application-level operations of applications 123 are executed by an application processor 121 within an isolated environment.

In an embodiment, at 211, the application node, interfaces with an external system that is external to the application node 120 and a security node 130 over an external network port 125 on the application node 120. The application node 120 directly receives and processes all external network communications.

At 220, the security manager controls peripheral-based operations on the security node 130. In an embodiment, at 221, the security node 130, authenticates each peripheral device connected to the security node 130 via a corresponding peripheral port 134. The security node 130 also encrypts communications with a corresponding peripheral device during each authenticated connection.

At 230, the security manager interfaces the application node 120 and the security node 130 together via a secure wired motherboard connection between the application node 120 and the security node 130. In an embodiment, at 231, the application node 120 and the security node 130 encrypt communications over the secure wired motherboard connection.

In an embodiment, at 240, the security manager processes a media-based transaction on the application node 120 and the security node 130 using the secure wired motherboard connection. The security node 130 directly processes peripheral communications and indirectly communicates relevant peripheral communications to the application node 120 via the secure wired motherboard connection.

In an embodiment of 240 and at 241, the security node 130 receives the peripheral communications over peripheral ports 134 of the security node 130. In an embodiment of 241 and at 242, the security node 130 authenticates connections to peripheral devices over the peripheral ports 134 and encrypts the peripheral communications during the connections.

In an embodiment, at 250, the security manager (210-230) processes a secure transaction terminal gateway device 110 for media-based transactions of an ATM. In an embodiment, the security manager (210-230) processes as a secure transaction terminal gateway device 110 for media-based transactions of an SST or a POS terminal.

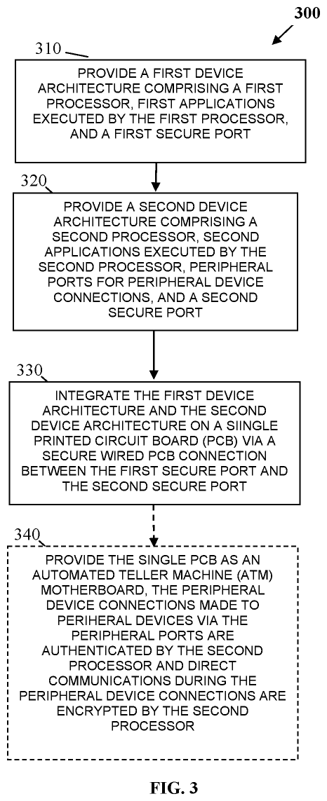

FIG. 3 is a flow diagram of another method 300 for operating a secure transaction terminal gateway device 110 according to an example embodiment. The software module(s) that implements the method 300 is referred to as a “gateway manager.” The gateway manager is implemented as executable instructions programmed and residing within memory and/or a non-transitory computer-readable (processor-readable) storage medium and executed by one or more processors of one or more devices. The processor(s) of the device(s) that executes the gateway manager are specifically configured and programmed to process the gateway manager. The gateway manager may or may not have access to one or more network connections during its processing. Any network connections used are wired, wireless, or a combination of wired and wireless.

In an embodiment, the device that executes the gateway manager is secure transaction terminal gateway device 110. In an embodiment, the secure transaction terminal gateway device 110 is an ATM, a POS terminal, or an SST. In an embodiment, the terminal gateway device 110 includes a peripheral connection to a media handling device.

At 310, the gateway manager provides a first device architecture 120, which includes a first processor 121, first applications 123 executed by the first processor 121, and a first secure port 127. At 320, the gateway manager provides a second device architecture, which includes a second processor 131, second applications 133 executed by the second processor 131, peripheral ports 134 for peripheral device connections, and a second secure port 136.

At 330, the gateway manager integrates the first device architecture 120 and the second device architecture 130 on a single PCB 110 via a secure wired PCB connection between the first secure port 127 and the second secure port 136. In an embodiment, at 340, the gateway manager provides the single PCB 110 as an ATM motherboard. The peripheral device connections are directly made to peripheral devices via the peripheral ports 134. Furthermore, the second processor 131 authenticates each peripheral device connection and encrypts communications during the peripheral device connections.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner. Furthermore, although the software modules are illustrated as executing on one piece of hardware, the software may be distributed over multiple processors or in any other convenient manner.

The above description is illustrative, and not restrictive. Other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A system, comprising:
a single motherboard comprising:
an application processing environment;
a secure processing environment; and
a secure wired on-motherboard connection between the application processing environment and the secure processing environment.

2. The system of claim 1, wherein secure processing environment includes a secure processor and peripheral ports for peripheral device connections to the secure processing environment.

3. The system of claim 2, wherein application processing environment includes an application processor and a secure network port to a secure external network that is external to the single motherboard.

4. The system of claim 3, wherein application processing environment includes an application secure port for the secure wired on-motherboard connection and the secure processing environment includes a secure port for the secure wired on-motherboard connection.

5. The system of claim 1, wherein the secure processing environment includes a secure processor to execute security applications that authenticate peripheral connections requested of the secure processing environment and that encrypt peripheral communications over the connections.

6. The system of claim 5, wherein the application processing environment includes an application processor that executes a media-based transaction application to indirectly communicate with peripheral devices of the connections via the secure wired on-motherboard connection.

7. The system of claim 1, wherein the secure processing environment includes a wireless transceiver and a secure processor to execute security applications that authenticate wireless device connections requested of the secure processing environment and that encrypt wireless communications over the wireless device connections.

8. The system of claim 7, wherein the application processing environment includes an application processor that executes a media-based transaction application to indirectly communicate with wireless devices of the wireless device connections via the secure wired on-motherboard connection.

9. The system of claim 1, wherein single motherboard is an automated teller machine (ATM) motherboard for an ATM device.

10. The system of claim 1, wherein the application processing environment is a first independent device, and the secure processing environment is a second independent device, wherein the secure wired on-motherboard connection integrates the first independent device with the second independent device on a single printed circuit board (PCB) as a secure transaction terminal gateway device.

11. A method, comprising:
controlling application-based operations on an application node;
controlling peripheral-based operations on a security node; and
interfacing the application node and the security node via a secure wired motherboard connection between the application node and the security node.

12. The method of claim 11 further comprising, processing a media-based transaction on the application node and the security node using the secure wired motherboard connection with peripheral communications directly processed on the security node and indirectly communicated to the application node via secure wired motherboard connection.

13. The method of claim 12, wherein processing further includes receiving the peripheral communications over peripheral ports on the security node.

14. The method of claim 13, wherein receiving further includes authenticating, by the security node, connections to peripheral devices over the peripheral ports, and encrypting, by the security node, the peripheral communications during the connections.

15. The method of claim 11 further comprising, processing the method as a secure transaction terminal gateway device for media-based transaction of an automated teller machine (ATM).

16. The method of claim 11, wherein controlling the application-based operations further includes interfacing, by the application node, with an external system that is external to the application node and the security node over an external network port on the application node.

17. The method of claim 16, wherein controlling the peripheral-based operations further includes authenticating, by the security node, each peripheral device connected to the security node via a corresponding peripheral port of the security node and encrypting, by the security node, communications with a corresponding peripheral device during each authenticated connection.

18. The method of claim 11, wherein interfacing further includes encrypting, by the application node and by the security node, communications over the secure wired motherboard connection.

19. A method, comprising:
providing a first device architecture comprising a first processor, first applications executed by the first processor, and a first secure port;
providing a second device architecture comprising a second processor, second applications executed by the second processor, peripheral ports for peripheral device connections to the second device architecture, and a second secure port;
integrating the first device architecture and the second device architecture on a single printed circuit board (PCB) via a secure wired PCB connection between the first secure port and the second secure port.

20. The method of claim 19 further includes providing single PCB as an automated teller machine (ATM) motherboard, wherein the peripheral device connections made to peripheral devices via the peripheral ports are authenticated by the second processor and direct communications during the peripheral device connections are encrypted by the second processor.
